(19) United States
(12) Patent Application Publication
(10) Pub. No.: US 2015/0018467 A1
(43) Pub. Date: Jan. 15, 2015

(54) NUCLEATING AGENTS FOR BIOPOLYMERS

(71) Applicants: TECHNISCHE UNIVERSITEIT EINDHOVEN, Eindhoven (NL); MAASTRICHT UNIVERSITY, Maastricht (NL)

(72) Inventors: Sanjay Rastogi, Eindhoven (NL); Yogesh Deshmukh, Roermond (NL); Piming Ma, Eindhoven (NL); Carolus Wilsens, Eindhoven (NL)

(21) Appl. No.: 14/379,404

(22) PCT Filed: Feb. 11, 2013
(86) PCT No.: PCT/EP2013/052647

§ 371 Date: Aug. 18, 2014

(30) Foreign Application Priority Data
Feb. 16, 2012 (EP) 12155715.1

(51) Int. Cl. C08K 5/20

(52) U.S. Cl. CPC C08K 5/20
USPC 524/219

(57) ABSTRACT

A compound or a combination of compounds for crystallization of poly-hydroxy-alkanoate (PHA), poly-lactic acid (PLA) or combinations thereof, wherein each of the compounds has a core motif with two oxalamide motifs, flanked by two arms, wherein the core motif has the formula: R—NH—C(O)—C(O)—NH—(CH₂)ₙ—NH—C(O)—C(O)—NH—R′, wherein n ranges from 1 to 10 and the arms R and R′ are each independently chosen from: (i) H; (ii) an alkyl group with a total number of carbon atoms between 1 and 20; (iii) an aromatic ring; or (iv) an ester group, for example —X-Ester-Y, or —X-Ester-X-Ester-Y, wherein X is a saturated aliphatic hydrocarbon group having 1 to 20 carbon atoms, Y is chosen from H, an alkyl group with a total number of carbon atoms ranging from 1 and 20 or an aromatic ring. Also described are processes for the crystallization of poly-hydroxy-alkanoate, poly-lactic acid, or combinations thereof.

### BACKGROUND

Polymers from natural resources are being developed to replace polymers produced from petrochemical resources. Well-known biopolymers are polyhydroxyalkanoates (PHAs) and poly(lactic) acid (PLA). Polyhydroxyalkanoates or PHAs are linear polyesters produced in nature and fermenters by bacterial fermentation of sugar or lipids. They can be either thermoplastic or elastomeric materials, with melting points ranging from 40° C. to 180° C. The most commonly produced form of PHA is poly(3-hydroxybutyrate) (P3HB) which was discovered in Bacillus megaterium in 1926. The mechanical and thermal properties of polyhydroxybutyrates (PHB) are similar to those of polypropylene, where the latter, a well-known commodity plastic, is obtained from petrochemical resources. The monomer units of PHB are all in D-configuration owing to the stereo specificity of the biosynthetic enzymes of the microbial strains. The stereo-specific nature of the polymer implies that PHB is a crystallizable polymer, but crystallization does not occur within the cell due to the lack of nucleation.

More than 100 different monomer units of PHAs have been identified as the constituents of PHAs. PHA structures can vary in two ways. First, PHA can vary due to the structure of the pendant groups which form the side chain of hydroxyalkanoic acid not contributing to the PHA backbone. Second, PHA can vary according to the number and types of units from which they are derived. Therefore, PHA can be present as a homopolymer, a copolymer, terpolymer, or higher combinations of monomers. This creates the possibility of producing biodegradable PHAs with a wide range of properties, from thermoplastic to elastomeric materials.

Poly(lactic acid) or polylactide (PLA) is a thermoplastic aliphatic polyester. The monomer lactic acid (LA) can be derived from renewable resources, such as corn starch, tapioca products or sugarcanes. PLA can be synthesized either from lactic acid via a polycondensation reaction or from cyclic lactide dimers via a ring opening polymerization (ROP). It can be biodegrade under certain conditions, such as in the presence of oxygen.

Some technical drawbacks limit the application of biopolymers. One of the major drawbacks is the poor crystallization rate due to the low nucleation efficiency. To increase the nucleation efficiency nucleating agents are used.

Nucleating agents for polyhydroxyalkanoates and polylactic acid are known.

U.S. Pat. No. 5,973,100 describes a nucleating agent for PHA and other thermoplastic polyesters which is based on organophosphorous compounds consisting of at least two phosphoric acid moieties. It can be used in combination with effective nucleating agent solvents, organic metal salts, inorganic metal oxides, metal hydroxides or metal carbonates, and/or weak organic bases and shows an increase in polymer crystallization rates.

U.S. Pat. No. 6,774,158 describes a nucleating agent for PHAs specifically for producing tough and flexible polymers for film-based products. Polyhydroxybutyrate, talc, mica, calcium carbonate or other salts are used as nucleant in combination with a plasticizer. The plasticizer can e.g. be maleate, laureate, fumarate, citrate or different oils.

US 20050209377A1 discloses the use of nucleants for the crystallization of thermoplastic polyester, especially polybutylene succinates, polycaprolactones, polyhydroxyalkanoates, polyglycolic acids, polylactic acids, and combinations thereof. The nucleant includes a compound that includes a nitrogen-containing heteroaromatic core, e.g. pyridine, pyrimidine, pyrazine, pyridazine, triazine, or imidazole. Preferably it contains the triazine cyanuric acid.

US 20060058498 shows the use of a nucleating agent in a process for crystallizing a polymer having at least 20 mole percent of hydroxyalkanoate repeat units. Essentially, the nucleating agent comprises an amide motif or 2 amide motifs which are linked by an alkylene or alkyl moiety. The melting point of the described nucleating agents varies between 160 and 175° C. A drawback of these nucleating agents is their limited thermal stability. One possible compound according to this invention is behenamide which starts to degrade at approximately 200° C. This means that the nucleating agents cannot be used in processing reactions at higher temperatures.

US 20090060860 discloses that beta-cyclodextrin, a cellulose-based compound that can be used as nucleating agent for PLA. When using 30 wt % of the nucleating agent an increase in crystallinity from 1.47% (without nucleating agent) to 17.85% has been observed in PLA.

CN101857715(A) achieves the quick crystallization of PLA with an organic compound comprising four amid motifs and modified benzyl side arms. The use of dicarboxylic acid chlorides as starting compounds makes the synthesis of this model compound prone to side reactions resulting in multiple time consuming purification steps. Furthermore, these nucleating agents use benzoic hydrazide as starting compound which is known to be highly toxic and is suspected to be carcinogenic.

EP1477526A1 and EP1795560A1 describe the use of amide compounds in the crystallization of PLA resins. Both documents show that nucleating agents with multiple amide groups can be used. However, the nucleating agents comprise hydrazide or dihydrazide moieties. The starting compound to prepare these nucleating agents (hydrazide) is toxic.

### BRIEF SUMMARY

The aim of present invention is to provide a nucleating agent with high nucleation efficiency and a high melting temperature for the biopolymers PHA and PLA. The nucleating agents of present invention also allow for a high onset crystallization temperature of the polymer when mixed with it and result in a high degree of crystallinity of the polymer.

This task is solved by using a compound or a combination of compounds for crystallization of poly-hydroxy-alkanoate (PHA), poly-lactic acid (PLA) or combinations thereof, characterized in that each of said compounds comprises a core motif with two oxalamide motifs, flanked by two arms, wherein said core motif has the formula:

R—NH—C(O)—C(O)—NH—(CH₂)ₙ—NH—C(O)—C(O)—NH—R′, wherein n is between 1 and 10 and the arms R and R′ are each independently of one another chosen from:

(i) H;

(ii) an alkyl group with a total number of carbon atoms between 1 and 20;

(iii) an aromatic ring; or

(iv) one of the following esters:

—X-Ester-Y,

—X-Ester-X-Ester-Y,

—X-Ester-X-Ester-X-Ester-Y,

—X-Ester-X-Ester-X-Ester-X-Ester-Y,

—X-Ester-X-Ester-X-Ester-X-Ester-X-Ester-Y,

—X-Ester-X-Ester-X-Ester-X-Ester-X-Ester-X-Ester-Y,

—X-Ester-X-Ester-X-Ester-X-Ester-X-Ester-X-Ester-X-Ester-Y, or

—X-Ester-X-Ester-X-Ester-X-Ester-X-Ester-X-Ester-X-Ester-X-Ester-Y;

wherein X is a saturated aliphatic hydrocarbon group comprising 1 to 20 carbon atoms, Y is chosen from H, an alkyl group with a total number of carbon atoms between 1 and 20 or an aromatic ring and Ester is —C(O)—O— or —O—C(O)—.

### DETAILED DESCRIPTION

An ester is a group containing a carbonyl connected to an oxygen atom (—C(O)—O—) or an oxygen atom connected to a carbonyl group (—O—C(O)—).

The saturated aliphatic hydrocarbon group (referred to as X) comprising 1 to 20 carbon atoms is part of an alkane chain and only consists of carbon and hydrogen atoms. All carbons are bound to each other by single carbon bonds. X includes unbranched carbon chains and branched carbon chains, i.e. isomers where the total number of carbon atoms is limited to 20.

The saturated aliphatic hydrocarbon group is bound to the other moieties of the nucleating agent by two separate bonds.

Examples are: —CH₂—CH₂—CH₂— or —CH₂(CH₃)—CH₂—.

An alkyl is an aliphatic moiety with a total number of carbon atoms between 1 and 20. This definition includes unbranched carbon chains and branched carbon chains, i.e. isomers.

Examples are: methyl, ethyl, propyl or isopropyl.

An aromatic ring is a five or six membered conjugated cyclic carbon ring. Aromatic rings include homocyclic compounds and heterocyclic compounds, the latter possibly containing oxygen, nitrogen or sulfur molecules. Non-restrictive examples are furan, pyrolle, thiophene, imidazole, pyrazole, oxazole, benzene and pyridine.

For example, a compound according to this invention comprising the core motif and symmetric arms can have the following structural formula:

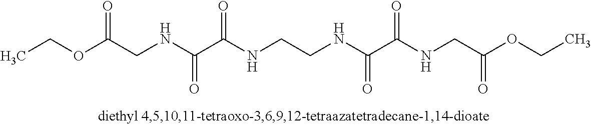 [SMILES: CCOC(=O)CNC(=O)C(=O)NCCNC(=O)C(=O)NCC(=O)OCC]

or with a different arm R:

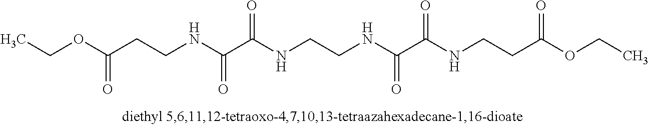 [SMILES: CCOC(=O)CCNC(=O)C(=O)NCCNC(=O)C(=O)NCCC(=O)OCC]

The following compounds are also nucleating agents according to present invention. These non-limiting examples include compounds with a symmetric structure (R′ is identical to R), as e.g. N¹,N^{1′}-(butane-1,4-diyl)dioxalamide, N¹,N^{1′}-(butane-1,4-diyl)bis(N²-ethyloxalamide), N¹,N^{1′}-(butane-1,4-diyl)bis(N²-(furan-2-yl)oxalamide) and bis(1-methoxy-1oxopropan-2-yl)2,15-dimethyl-4,5,12,13-tetraoxo-3,6,11,14-tetraazahexadecane-1,16-dioate;

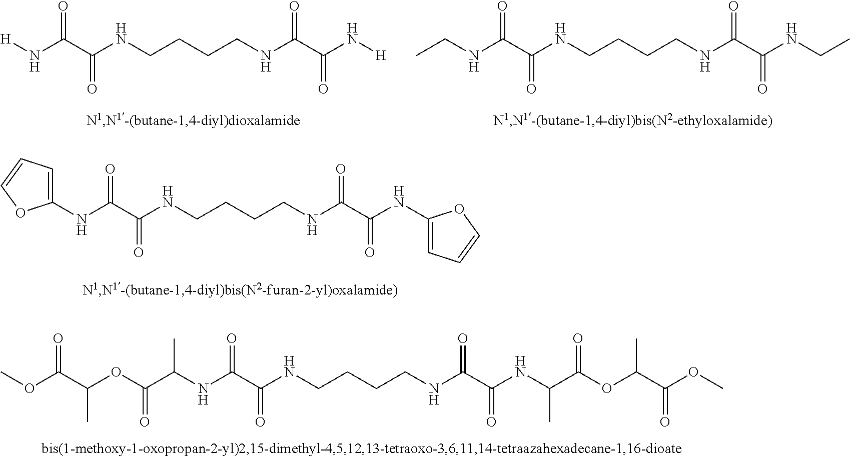

and nucleating agents with asymmetric flanking arms (R and R′ are different), as e.g. N¹-(4-(2-amino-2-oxoacetamido)butyl)-N²-phenyloxalamide, propyl-16-methyl-4,5,12,13-tetraoxo-3,6,11,14-tetraazaheptadecan-17-oate and 2,5-dimethyl-4,7,8,15,16-pentaoxo-3-oxa-6,9,14,17-tetraazahenicosan-1-oic acid. The structural formulas of these compounds are depicted below:

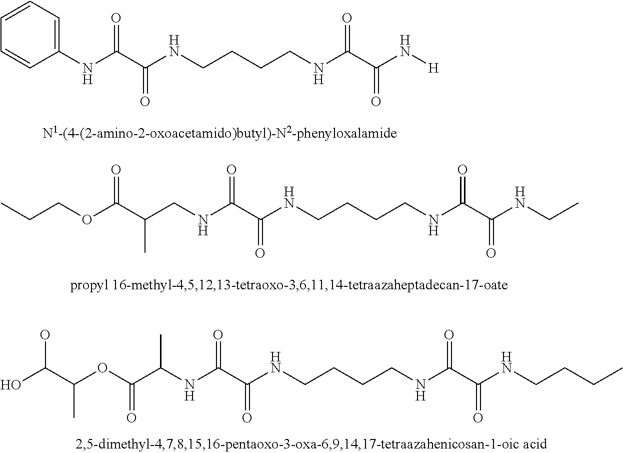 [SMILES: NC(=O)C(=O)NCCCCNC(=O)C(=O)Nc1ccccc1 ; CCCOC(=O)C(C)CNC(=O)C(=O)NCCCCNC(=O)C(=O)NCC ; CCCCNC(=O)C(=O)NCCCCNC(=O)C(=O)NC(C)C(=O)OC(C)C(O)O]

The core motif comprises two oxalamide motifs. Amide motifs are hydrogen bonding motifs. They are the driving force for crystallization of the polymer. Because multiple amide motifs are present in the compound the hydrogen bonding is very strong. The hydrogen bonding leads to self-assembly of compound molecules which form long needle-like structures that act as nucleating agent for the polymer.

In the present invention the oxalamide motifs are connected by a linear aliphatic linker of the structural formula —(CH₂)ₙ—, which can differ in length between a methyl moiety (n=1) and a decanyl moiety (n=10). The different length of the linear aliphatic linker influences the peak melting and crystallization temperature of the compound in such a manner that a longer spacer decreases the melting temperature while a shorter spacer increases the melting temperature (Table 1). The length of the aliphatic spacer can be used as a tool to design the optimal compound for a specific polymer in terms of its solubility and melting temperature. Control of the melting point is essential to use the compound as efficient nucleating agent with different polymers and co-polymers which have a wide range of melting temperatures.

Preferably, the nucleating agents according to present invention have peak melting temperatures ranging from 170 to 300° C.

For example, diethyl 4,5,10,11-tetraoxo-3,6,9,12-tetraazatetradecane-1,14-dioate has a peak melting temperature of 242° C.

TABLE 1
Melting and crystallization temperature of a number of
nucleating agents according to this invention

| | Spacer Length | | |
|---|---|---|---|
| | (no. of methylene | T_{m-NA} | T_{c-NA} |
| Nucleating Agent | carbon) | (° C.) | (° C.) |
| Diethyl 4,5,10,11-tetraoxo-3,6,9,12- | 2 | 237 | 232 |
| tetraazatetradecane-1,14-dioate | | | |
| Diethyl 4,5,14,15-tetraoxo-3,6,13,16- | 6 | 181 | 174 |
| tetraazaoctadecane-1,18-dioate | | | |
| Diethyl 5,6,11,12-tetraoxo-4,7,10,13- | 2 | 261 | 256 |
| tetraazahexadecane-1,16-dioate | | | |
| Diethyl 5,6,15,16-tetraoxo-4,7,14,17- | 6 | 200 | 194 |
| tetraazaicosane-1,20-dioate | | | |

T_{m-NA}—peak melting temperature of the nucleating agent
T_{c-NA}—peak crystallization temperature of the nucleating agent

The high melting temperature of the compounds is an advantage of the present invention over nucleating agents known previously. The high melting temperature results in a very high nucleation efficiency of the nucleating agent. It also allows for the use of the compound or a combination of compounds as nucleation agent for polymers with a high melting temperature. For example, a 50/50 mixture of PLLA/PDLA has a melting temperature of 230° C.

The melting point (or dissolution temperature) of the nucleating agent decreases when mixed with the polymer. For example 0.5 wt % or 1 wt % of diethyl 4,5,10,11-tetraoxo-3,6,9,12-tetraazatetradecane-1,14-dioate in a PHB polymer matrix melts below 190° C., clearly indicating suppression of the melting temperature. The decrease in melting point of the nucleating agent suggests its good miscibility in the polymer melt.

The formula of the arms R and R′ is chosen in a way to improve the miscibility with the polymer. A good miscibility of the nucleating agent with the polymer causes a homogenous distribution of the nucleating agent in the polymer matrix and leads to better crystallization. This is obtained by designing the arms to be similar to the molecular configuration of the polymer. When R, R′ and the molecular configuration of the polymer to be crystallized are similar, the crystal structure of the compound suppresses the nucleation barrier and increases the nucleation efficiency of the polymer, thus increasing the crystallization rate.

For the crystallization of PHA and PLA the flanking arms are independently of each other chosen from

(i) H;

(ii) an alkyl group with a total number of carbon atoms between 1 and 20;

(iii) an aromatic ring; or

(iv) one of the following esters:

—X-Ester-Y,

—X-Ester-X-Ester-Y,

—X-Ester-X-Ester-X-Ester-Y,

—X-Ester-X-Ester-X-Ester-X-Ester-Y,

—X-Ester-X-Ester-X-Ester-X-Ester-X-Ester-Y,

—X-Ester-X-Ester-X-Ester-X-Ester-X-Ester-X-Ester-Y,

—X-Ester-X-Ester-X-Ester-X-Ester-X-Ester-X-Ester-X-Ester-Y, or

—X-Ester-X-Ester-X-Ester-X-Ester-X-Ester-X-Ester-X-Ester-X-Ester-Y;

wherein X is a saturated aliphatic hydrocarbon group comprising 1 to 20 carbon atoms, Y is chosen from H, an alkyl group with a total number of carbon atoms between 1 and 20 or an aromatic ring and Ester is —C(O)—O— or —O—C(O)—. In some embodiments, the (potentially repeated) X-Ester motif occurring in the side group R is similar to the repeat units of PHA or PLA once incorporated in polymers. This will increase the miscibility of the nucleating agent with the polymer and will improve the crystallization of the polymer matrix.

The nucleating agents according to present invention can be used to crystallize the biopolymers PHA and PLA.

For the purpose of this invention PHA is defined as a polymer comprising various possible PHA monomers known to the person skilled in the art, with varying possible pendant groups in the side chains, including homopolymers, copolymers, terpolymers and higher combinations of monomers, for example including the following polyhydroxybutyrates: poly-hydroxybutyrate-hydroxyvalerate (PHBHV) and poly-hydroxybutyrate-hydroxyhexanoate (PHBHH).

PLA includes the stereo complexes P(L)LA, P(D)LA and all possible combinations thereof. Depending on the stereo-chemical purity of the monomer feed, the ratio L-LA versus D-LA, PLAs can be obtained with a variety of stereo-chemical purity, from pure P(L)LA and pure P(D)LA to P(D/L)LA copolymers and P(L)LA/P(D)LA stereocomplexes.

In one embodiment the polymer to be crystallized is a combination of PHA and PLA. In this combination of polymers, PHA and PLA each can be present in varying percentages based on the total amount of polymer.

In one embodiment according to this invention one compound according to the invention can be used to crystallize PLA or PHA or combinations thereof. In another embodiment a combination of compounds according to present invention is used to crystallize PHA or PLA. For this purpose 0.05-2 wt %, preferably 0.1-1 wt %, more preferably 0.25-0.5 wt % of the compound or the combined compounds based on the weight of the polymer are used for crystallization.

If a combination of compounds is used to crystallize PLA or PHA or combinations thereof, said amount refers to the combined amount of the different compounds. This means that the total amount of nucleating agent added to the polymer can either consist of one nucleating agent or of a combination of different nucleating agents. For example, 0.05 wt % of nucleating agent A and 0.05 wt % of nucleating agent B result in 0.1 wt % of the combined compounds based on the weight of the polymer. The relative amount of each compound of such a combination can vary depending on the polymer or polymer mixture to be crystallized.

In another embodiment the invention relates to a process for the crystallization of poly-hydroxy-alkanoate or poly-lactic acid or combinations thereof, comprising the steps of:

(a) mixing poly-hydroxy-alkanoate or poly-lactic acid with a compound or a combination of compounds at a first temperature, ranging from 5° C. to 120° C. above the onset of melting point of the polymer; and

(b) cooling the polymer at a second temperature, ranging from the first temperature to 20° C. below the glass transition temperature of the polymer, characterized in that each of said compounds comprises a core motif with two oxalamide motifs, flanked by two arms, wherein said core motif has the formula: R—NH—C(O)—C(O)—NH—(CH₂)ₙ—NH—C(O)—C(O)—NH—R′, wherein n is between 1 and 10 and the arms R and R′ are each independently of one another chosen from:

(i) H;

(ii) an alkyl group with a total number of carbon atoms between 1 and 20;

(iii) an aromatic ring; or

(iv) one of the following esters:

—X-Ester-Y,

—X-Ester-X-Ester-Y,

—X-Ester-X-Ester-X-Ester-Y,

—X-Ester-X-Ester-X-Ester-X-Ester-Y,

—X-Ester-X-Ester-X-Ester-X-Ester-X-Ester-Y,

—X-Ester-X-Ester-X-Ester-X-Ester-X-Ester-X-Ester-Y,

—X-Ester-X-Ester-X-Ester-X-Ester-X-Ester-X-Ester-X-Ester-Y, or

—X-Ester-X-Ester-X-Ester-X-Ester-X-Ester-X-Ester-X-Ester-X-Ester-Y;

wherein X is a saturated aliphatic hydrocarbon group comprising 1 to 20 carbon atoms, Y is chosen from H, an alkyl group with a total number of carbon atoms between 1 and 20 or an aromatic ring and Ester is —C(O)—O— or —O—C(O)—.

The nucleating agents according to the invention show high nucleation efficiencies. The nucleation efficiency is defined as the increase of the crystallization temperature of the polymer with the nucleating agent compared to the crystallization temperature without nucleating agent.

PHA and PLA barely crystallize without a nucleating agent. Instead, glass transition can be observed. Glass transition means that the viscosity of the amorphous component in the semi-crystalline polymer partly changes from the amorphous to the liquid state or vice versa depending on heating or cooling. For example, glass transition of PHB occurs at ca. 5° C., glass transition of PLA occurs at approximately 60° C. However, with the here described nucleating agents or combinations thereof the onset temperature for crystallization of the polymer is increased by between 5° C.-100° C. The specific temperature depends on the amount of nucleating agent and the polymer. A higher onset crystallization temperature is better for the produced plastics because the mechanical properties of the material are better, the production time is lower because less cooling has to take place and no or less shrinking of the crystallized polymer occurs. The high nucleation efficiency provides the desired dimensional stability. Thus, the high onset crystallization temperature of the polymer in the presence of the nucleating agents of present invention enables easier processability and a higher dimensional stability of the shaped polymer product.

Preferably, the onset crystallization temperature of the polymer in the presence of a nucleating agent or combination of nucleating agents is increased by at least 10° C., more preferably at least 15° C. or even more preferably at least 20° C. or at least 25° C. compared to the polymer without any nucleating agent.

With the nucleating agents according to this invention the temperature at which the polymer and the compound are mixed ranges between 5° C. and 120° C., preferably between 5 and 90° C., more preferably between 5° C. and 60° C. above the onset of the melting temperature of the polymer.

Compared to the nucleating agents known in the art the nucleating agents of present invention allow a much higher crystallization temperature of the polymer. This results in better mechanical properties of the product, shorter production cycle time and therefore lower production costs.

The temperature at which the polymer and nucleating agent are cooled ranges from about 50° C. above the onset of the melting temperature of the polymer to 20° C. below the glass transition temperature of the polymer, preferably from 30° C. above the onset of the melting temperature of the polymer to 10° C. below the glass transition temperature of the polymer, more preferably from 10° C. above the onset of the melting temperature of the polymer to about the glass transition temperature of the polymer. As pointed out before a high crystallization temperature is beneficial for the polymer product and its production.

The cooling occurs at a rate ranging between 1° C./min and 500° C./min, preferably between 10° C./min and 500° C./min, more preferably between 20° C./min and 100° C./min.

With increasing cooling rate the nucleation efficiency becomes more evident and it reduces production time.

In another embodiment the invention relates to a composition comprising a polymer and a compound or a combination of compounds, wherein said polymer is poly-hydroxy-alkanoate or poly-lactic acid, characterized in that each of said compounds comprises a core motif with two oxalamide motifs, flanked by two arms, wherein said core motif has the formula:

R—NH—C(O)—C(O)—NH—(CH₂)ₙ—NH—C(O)—C(O)—NH—R′, wherein n is between 1 and 10 and the arms R and R′ are each independently of one another chosen from:

(i) H;

(ii) an alkyl group with a total number of carbon atoms between 1 and 20;

(iii) an aromatic ring; or

(iv) one of the following esters:

—X-Ester-Y,

—X-Ester-X-Ester-Y,

—X-Ester-X-Ester-X-Ester-Y,

—X-Ester-X-Ester-X-Ester-X-Ester-Y,

—X-Ester-X-Ester-X-Ester-X-Ester-X-Ester-Y,

—X-Ester-X-Ester-X-Ester-X-Ester-X-Ester-X-Ester-Y,

—X-Ester-X-Ester-X-Ester-X-Ester-X-Ester-X-Ester-X-Ester-Y, or

—X-Ester-X-Ester-X-Ester-X-Ester-X-Ester-X-Ester-X-Ester-X-Ester-Y;

wherein X is a saturated aliphatic hydrocarbon group comprising 1 to 20 carbon atoms, Y is chosen from H, an alkyl group with a total number of carbon atoms between 1 and 20 or an aromatic ring and Ester is —C(O)—O— or —O—C(O)—.

More specifically, the compound or a combination of compounds can be used for the crystallization of polymers that can be further processed to replace plastic carrier bags, bottles and food packaging products by possibly biodegradable products. The oxalamide motif of the nucleating agents of present invention is not toxic and likely to be biodegradable. The nucleating agents which comprise the oxalamide motifs in combination with ester bonds are especially likely to be biodegradable. When using a biodegradable nucleating agent in combination with a biopolymer, the resulting product can be completely biodegradable.

Therefore polymer products produced with the nucleating agents according to this invention could be completely biodegradable.

The following examples describe the invention in more detail but by no means limit the scope of the invention.

### Synthesis of Compounds & Methods for Measuring the Characteristics of the Compounds and Compound-Polymer Compositions

1. Synthesis of diethyl 2,2′-(ethane-1,2-diylbis(azanediyl))bis(2-oxoacetate) was achieved by reaction of 1,2-diaminoethane with diethyloxalate in tetrahydrofuran (THF). Diethyl 2,2′-(ethane-1,2-diylbis(azanediyl))bis(2-oxoacetate) was obtained as a white powder. It shows a melting point of 130° C. and re-crystallizes at 121° C. In a second step diethyl 4,5,10,11-tetraoxo-3,6,9,12-tetraazatetradecane-1,14-dioate was synthesized by reaction of glycine ethyl ester hydrochloride and diethyl 2,2′-(ethane-1,2-diylbis(azanediyl))bis(2-oxoacetate) in chloroform in the presence of triethyl amine. The product was obtained after purification as a white powder, showed a melting point of 237° C. and a crystallization point at 232° C. The compound is thermally stable up to 265° C.

Diethyl 5,6,11,12-tetraoxo-4,7,10,13-tetraazahexadecane-1,16-dioate was prepared from β-alanine ethyl ester hydrochloride and diethyl 2,2′-(ethane-1,2-diylbis(azanediyl))bis(2-oxoacetate) in chloroform in the presence of triethyl amine. The product was obtained after purification as a white powder, showed a melting point of 261° C. and a crystallization point of 256° C. and is thermally stable up to 270° C. as determined by Thermal Gravimetric Analysis.

### 2. Melt Mixing

Melt mixing of the nucleating agent and the polymers was performed using a mini-extruder with sample residence time of 5 min after complete feeding. All the samples were prepared using 0.25 wt %, 0.5 wt %, 1 wt % or 1.5 wt % of the nucleating agent based on the amount of polymer. PHB was processed at 210° C. while PLA was processed at 220° C. For the following examples PHB (containing 2 mole % hydroxyvaleric acid), one of the poly hydroxy alkanoates, was provided by Tianan Biologic Material Co. Ltd., Ningbo, China, with an average molecular weight of 230,000 g/mol. Poly (L-lactic acid) (PLLA), experimental grade, was purchased from Purac, having a glass transition temperature of ˜60° C., melting temperature of 172° C. and a molecular weight of ˜200,000 g/mol.

3. Thermo Gravimetric Analysis (TGA): The thermal stability of nucleating agents was investigated using TGA instruments (TA Instruments Q500) under nitrogen atmosphere with heating at 10° C./min from 30° C. to 700° C.

### 4. Differential Scanning Calorimetry (DSC)

Melting and crystallization of polymers without and with nucleating agent was investigated using DSC (TA Q1000) instrument under nitrogen atmosphere. The heating rate was always 20° C./min and cooling rates of all samples were 100° C./min or 10° C./min with 3 min of isothermal condition at limiting temperatures. For Polyhydroxybutyrate (PHB) and Poly lactic acid (PLA), the samples were heated up to 190° C. and cooled down to 20° C. Isothermal crystallization measurements are performed on PHB without and with nucleating agent at 120° C. for an isothermal time of 1 hr.

The onset melting temperature is defined as the start of the endothermic process, whereas the peak melting temperature is defined as the peak of the endothermic process recorded by DSC.

### 5. Wide Angle X-Ray Diffraction (WAXD)

Diffraction patterns of the samples without and with nucleating agent were investigated using a Bruker AXS HISTAR area detector installed on a P4 diffractometer, using graphitemonochromated Cu Kα radiation (λ=1.5418 Å) and a 0.5 mm collimator. The data were collected from the sample at room temperature. The 2D data were background corrected and 1D was obtained after integrating the 2D pattern.

### 6. Optical Microscopy

Crystallization measurements were conducted on a Zeiss Axioplan 2 Imaging optical microscopy under crossed polarizers with a CD achorplan objective (Zoom). A THMS 600 heating stage connected to a Linkam TMS 94 control unit was mounted on the optical microscope. Samples were heated at a heating rate of 50° C./min from room temperature to above the melting temperature of the polymer (for PHB and PLA it was 190° C.) and cooled at a specific cooling rate under nitrogen atmosphere.

### ABBREVIATIONS AND SYMBOLS

NA1: Diethyl 4,5,10,11-tetraoxo-3,6,9,12-tetraazatetradecane-1,14-dioate
NA2: Diethyl 5,6,11,12-tetraoxo-4,7,10,13-tetraazahexadecane-1,16-dioate
Tₘ: Peak melting temperature of the polymer, nucleating agent or polymer in the presence of the nucleating agent (cf. Tables 2, 5 and 6)
T_{c}/T_{c}^{N}: Peak crystallization temperature of the polymer in the presence of the nucleating agent (T_{c}^{N}) or the pristine polymer (T_{c})
Tₒₙₛₑₜ: Onset crystallization temperature of the polymer in the presence of the nucleating agent or the pristine polymer
X_{c}: Percentage crystallinity of the polymer
t_{0.5}: Half time of isothermal crystallization of the polymer
ΔHₘ: Enthalpy of melting of the polymer
ΔH_{C}: Enthalpy of crystallization of the polymer

### Example 1

The crystal structure of NA1 was analyzed by WAXD and showed a triclinic unit cell having parameters such as a=0.31 nm, b=0.36 nm, c=1.71 nm, α=95.1, β=95.2 and γ=103.0, The peak melting point of NA1 is 242° C. The compound crystallizes on cooling, from melt, at 240° C. These temperatures have been determined using optical microscopy and Differential Scanning calorimetry.

Different concentrations of NA1 were melt-mixed with PHB and subsequently cooled at approximately 100° C./min. The crystallinity of the composition was analyzed by optical microscopy, DSC, isothermal crystallization and WAXD. The melting point (or dissolution temperature) of NA1 decreases when in composition with the polymer matrix. For example 1.0 wt % and 0.5 wt % of the nucleating agent in the polymer matrix (PHB) melt below 190° C., clearly indicating suppression of the melting temperature. On cooling, the nucleating agent crystallizes and forms a needle-like morphology that appears at 152° C. with 1.0 wt % and at 123° C. with 0.5 wt % of the nucleating agent, respectively.

The presence of the needle-like morphology of the nucleating agent enhances the nucleation efficiency of the polymer PHB in contrast to the polymer without the nucleating agent. The nucleation efficiency is defined as [1−(Tc^{N}−Tc)⁻¹]×100% (equation 1), where Tc^{N} is the peak crystallization temperature in the presence of nucleating agent and Tc is the peak crystallization temperature of the pristine polymer, without the nucleating agent. The nucleating efficiency of NA1 is shown in Table 2. The polymer without the nucleating agent crystallizes at 55° C., whereas the polymer with 0.5 wt % of the nucleating agent crystallizes at 94° C. resulting in a high nucleation efficiency of 97%.

PHB without the nucleating agent shows a much lower crystallinity (2%) due to the low nucleation density of the polymer alone. In contrast, the polymer with 0.5 wt % of NA1 shows fast crystallization and the optical view is filled with crystalline domains, leading to the crystallinity of 43%. The nucleating agent behenamide shows a lower crystallinity of 34% when present at 0.5 wt %.

TABLE 2
Crystallization of PHB with different concentrations of NA1
(DSC measurements)

| | T_{c}/ | | | | Nucleation | Cooling |
|---|---|---|---|---|---|---|
| | T_{c}^{N} | Tₒₙₛₑₜ | X_{c} | Tₘ | efficiency | rate |
| Sample | (° C.) | (° C.) | (%) | (° C.) | (%) | (° C./min) |
| NA1 | 232 | 232 | — | 237 | — | 10 |
| PHB | 55 | 76 | 2 | 171 | — | 100 |
| PHB + 0.25 wt % | 88 | 92 | 42 | 166 | 96 | 100 |
| NA1 | | | | | | |
| PHB + 0.5 wt % | 94 | 100 | 43 | 167 | 97 | 100 |
| NA1 | | | | | | |
| PHB + 1 wt % NA1 | 86 | 93 | 40 | 165 | 96 | 100 |

These findings have been further supported by isothermal crystallization at 120° C. (Table 3). From the data reported in table 3 it is evident that the polymer without the nucleating agent does not crystallize even on annealing the sample for more than an hour. In contrast the polymer with the nucleating agent crystallizes within five minutes leading to a crystallinity of more than 60%.

TABLE 3
Isothermal crystallization results of PHB with varying amount of
nucleating agent (NA1) obtained from DSC measurements.

| | | | | X_{c} from |
|---|---|---|---|---|
| | Isothermal | | ΔH_{c} | isothermal |
| | crystallization | | within | crystal- |
| | temperature | t_{0.5} | one hour | lization |
| Samples | (° C.) | (min) | (J/g) | (%) |
| PHB | 120 | >60 | 0 | 0 |
| PHB + 0.25 wt % NA1 | 120 | 9 | 89 | 61 |
| PHB + 0.5 wt % NA1 | 120 | 2.5 | 91 | 62 |
| PHB + 1.0 wt % NA1 | 120 | 7.0 | 82 | 56 |

In the presence of the nucleating agent, WAXD studies clearly show no modification in the crystal structure thus suggesting that the physical properties of the polymer, such as melting temperature will remain the same. This has been further confirmed by DSC.

### Example 2

To compare different nucleation agents described in the prior art with the nucleating agents of present invention, NA1 and five known nucleating agents were used to crystallize PHB as described in example 1.

Behenamide (behen.) is a well-known nucleating agent.
N,N′-(ethane-1,2-diyl)bis(6-hydroxyhexanamide (EDHA) and N,N′-(butane-1,4-diyl(bis(6-hydroxyhexanamide (BDHA) are bisamide compounds.
N′1,N′⁶-dibenzoyladipohydrazide (DBAHZ) and N′1, N′⁹-diheptanoylnonanedihydrazide (DHNHZ) are both dihydrazide compounds.

The results are shown in table 4.

TABLE 4
Crystallization of PHB with different nucleating agents (DSC
measurements)

| | | | | Nucleation | Cooling |
|---|---|---|---|---|---|
| | T_{c} | Tₒₙₛₑₜ | X_{c} | efficiency | rate |
| Sample | (° C.) | (° C.) | (%) | (%) | (° C./min) |
| PHB | 55 | 76 | 2 | — | 100 |
| PHB + 0.5 wt % NA1 | 94 | 100 | 43 | 97 | 100 |
| PHB + 0.5 wt % EDNA | 74 | 77 | 37 | 94 | 100 |
| PHB + 0.5 wt % BDHA | 43 | 51 | 24 | — | 100 |
| PHB + 0.5 wt % DBAHZ | 82 | 88 | 39 | 96 | 100 |
| PHB + 0.5 wt % DHNHZ | 61 | 80 | 5 | 95 | 100 |
| PHB + 0.5 wt % behen. | 62 | 66 | 34 | 85 | 100 |

In the presence of 0.5 wt % of the compound behenamide, the polymer crystallizes at 62° C., resulting in a nucleation efficiency of 85%. The nucleation efficiency of NA1 is significantly higher, at 97%. The bisamides and hydrazides result in nucleation efficiencies which are lower than with NA1. The onset crystallization temperature between the bisamides, dihydrazides and NA1 differs clearly. Only with NA1 the onset crystallization temperature is increased more than 20° C. when compared to the pristine polymer (100° C. instead of 76° C.). As pointed out before, this is advantageous because a lower crystallization temperature necessitates longer production times and can cause more shrinking of the crystallized polymer. Furthermore, the crystallinity of the polymer crystallized with the prior art nucleating agents is also lower compared to NA1. Very likely, the improved crystallization performance of the nucleating agents of present invention is at least partly a result of the good miscibility with the polymer. The miscibility of e.g. the dihydrazides comprising benzoic acid groups with the polymer is expected to be less.

### Example 3

The nucleation effect and efficiency of NA1 and NA2 for P(L)LA has been investigated. Table 5 summarizes the results obtained from DSC measurements. The samples were prepared via melt mixing of the nucleating agent and the polymer as described in the experimental section. The pristine P(L)LA without nucleating agent crystallized at 89° C. and has 11% crystallinity upon cooling at 10° C./min. At this cooling rate, in the presence of 1% wt of NA1 the crystallization temperature shifted to 99° C. and the crystallinity percentage increased to 33%. Calculated based on equation 1, this nucleating agent has a nucleation efficiency of 90% at 1 wt % concentration.

Using NA2 at 1 wt % in P(L)LA, the crystallization temperature and crystallinity percentage increased to 107° C. and 40% respectively, with the nucleating agent showing a nucleation efficiency of 94%. Further, the nucleation effect has been investigated using optical microscopy. Needle-like morphology of nucleating agent has been observed for the nucleating agent prior to crystallization of P(L)LA, when super cooled from melt state of the polymer.

TABLE 5
Nucleation efficiency of NA1 and NA2 for P(L)LA obtained from DSC
measurements.

| | | | | | Nucleation | Cooling |
|---|---|---|---|---|---|---|
| | T_{c} | Tₒₙₛₑₜ | X_{c} | Tₘ | efficiency | rate |
| Sample | (° C.) | (° C.) | (%) | (° C.) | (%) | (° C./min) |
| NA1 | 232 | 232 | — | 237 | — | 10 |
| NA2 | 256 | 257 | — | 261 | | 10 |
| PLLA | 89 | 104 | 11 | 172 | — | 10 |
| PLLA + | 99 | 109 | 33 | 173 | 90 | 10 |
| 1 wt % NA1 | | | | | | |
| PLLA + | 100 | 110 | 34 | 173 | 91 | 10 |
| 1.5 wt % NA1 | | | | | | |
| PLLA + | 107 | 118 | 43 | 174 | 94 | 10 |
| 1 wt % NA2 | | | | | | |
| PLLA + | 106 | 116 | 44 | 173 | 94 | 10 |
| 1.5 wt % NA2 | | | | | | |

### Example 4

To compare the crystallization kinetics of previously known nucleating agents and a nucleating agent according to this invention the enthalpy during heating and the thermal stability of the compounds was measured, as shown in Tables 6 and 7.

TABLE 6
Comparison of behenamide and NA1.

| | | ΔH_{c} | Tₘ | ΔHₘ |
|---|---|---|---|---|
| Polymer | T_{c} (° C.) | (J/g) | (° C.) | (J/g) |
| 1) PHB | 54.9 | 3.3 | 170.5 | 81.5 |
| 2) PHB with 0.5% wt behenamide | 62.2 | 48.6 | 169.6 | 80.1 |
| 3) PHB with 0.5% wt NA1 | 93.6 | 61.9 | 167.0 | 80.5 |

The cooling rate of the sample was 100° C./min. The peak melting temperature (Tₘ) and enthalpy (ΔHₘ) of the sample are measured during the second heating cycle. In the case of PHB and PHB mixed with 0.5 wt % behenamide, cold crystallization is observed. This eventually contributed to a relatively high melting enthalpy value.

The increase in the crystallization temperature (T_{c}) and enthalpy (ΔH_{c}) for PHB with 0.5% wt NA1 and less supercooling compared to the PHB or PHB with 0.5 wt % behenamide confirmed the higher nucleation efficiency of the nucleating agent according to this invention.

The thermal stability of nucleating agents is an important factor for the applicability of these compounds with polymers, especially for polymers which are processed at high temperatures. By thermographic analysis the thermal stability of NA1, NA2 and behenamide was compared in Table 7.

TABLE 7
Thermal stability of NA1 and NA2 in comparison
with behenamide.

| | Thermal stability temperature |
|---|---|
| Nucleating agent | (° C.) |
| NA1 | 265 |
| NA2 | 275 |
| Behenamide | 200 |

Behenamide is thermally stable up to 200° C., while the nucleating agents described in this invention, NA1 and NA2 are thermally stable up to 265° C. and 275° C., respectively. The thermal stability is measured as 1 wt % decomposition of the sample at elevated temperatures during the heating cycle.

This means that behenamide because of its rather low thermal stability is not suited to apply for processes carried out at above 200° C.

1. A process for the crystallization of poly-hydroxy-alkanoate, poly-lactic acid, or combinations thereof, the process comprising:
mixing a compound or a combination of compounds with poly-hydroxy-alkanoate, poly-lactic acid, or combinations thereof,
wherein the compound or at least one compound in the combination of compounds comprises a core motif with two oxalamide motifs, flanked by two arms, wherein the core motif has the formula:
R—NH—C(O)—C(O)—NH—(CH₂)ₙ—NH—C(O)—C(O)—NH—R′,
wherein n ranges from 1 to 10 and the arms R and R′ are each independently of one another selected from the group consisting of:
(i) H;
(ii) an alkyl group with a total number of carbon atoms ranging from 1 to 20;
(iii) an aromatic ring; and
(iv) one of the following esters:
—X-Ester-Y,
—X-Ester-X-Ester-Y,
—X-Ester-X-Ester-X-Ester-Y,
—X-Ester-X-Ester-X-Ester-X-Ester-Y,
—X-Ester-X-Ester-X-Ester-X-Ester-X-Ester-Y,
—X-Ester-X-Ester-X-Ester-X-Ester-X-Ester-X-Ester-Y,
—X-Ester-X-Ester-X-Ester-X-Ester-X-Ester-X-Ester-X-Ester-Y, or
—X-Ester-X-Ester-X-Ester-X-Ester-X-Ester-X-Ester-X-Ester-X-Ester-Y;
wherein X is a saturated aliphatic hydrocarbon group comprising 1 to 20 carbon atoms, Y is selected from the group consisting of H, an alkyl group with a total number of carbon atoms ranging from 1 to 20, and an aromatic ring, and Ester is —C(O)—O— or —O—C(O)—.

2. The process according to claim 1, wherein the compound or the at least one compound in the combination of compounds has a peak melting temperature ranging from 170 to 300° C.

3. The process according to claim 1, wherein the compound or the at least one compound in the combination of compounds is applied in a range of from 0.05 to 2 wt % based on a weight of the poly-hydroxy-alkanoate, poly-lactic acid, or the combinations thereof.

4. A process for crystallization of poly-hydroxy-alkanoate, poly-lactic acid, or combinations thereof, comprising:
mixing poly-hydroxy-alkanoate, poly-lactic acid, or combinations thereof with a compound or a combination of compounds at a first temperature, wherein the first temperature ranges from 5° C. to 120° C. above an onset of a melting point of the poly-hydroxy-alkanoate, poly-lactic acid, or the combinations thereof; and
cooling the poly-hydroxy-alkanoate, poly-lactic acid, or the combinations thereof at a second temperature, ranging from the first temperature to 20° C. below a glass transition temperature of the poly-hydroxy-alkanoate, poly-lactic acid, or the combinations thereof, wherein
the compound or each of the compounds in the combination of compounds comprises a core motif with two oxalamide motifs, flanked by two arms, wherein the core motif has the formula:
R—NH—C(O)—C(O)—NH—(CH₂)ₙ—NH—C(O)—C(O)—NH—R′, wherein n ranges from 1 to 10 and the arms R and R′ are each independently of one another selected from the group consisting of:
(i) H;
(ii) an alkyl group with a total number of carbon atoms ranging from 1 to 20;
(iii) an aromatic ring; and
(iv) one of the following esters:
—X-Ester-Y,
—X-Ester-X-Ester-Y,
—X-Ester-X-Ester-X-Ester-Y,
—X-Ester-X-Ester-X-Ester-X-Ester-Y,
—X-Ester-X-Ester-X-Ester-X-Ester-X-Ester-Y,
—X-Ester-X-Ester-X-Ester-X-Ester-X-Ester-X-Ester-Y,
—X-Ester-X-Ester-X-Ester-X-Ester-X-Ester-X-Ester-X-Ester-Y, or
—X-Ester-X-Ester-X-Ester-X-Ester-X-Ester-X-Ester-X-Ester-X-Ester-Y;
wherein X is a saturated aliphatic hydrocarbon group comprising 1 to 20 carbon atoms, Y is selected from the group consisting of H, an alkyl group with a total number of carbon atoms ranging from 1 to 20, and an aromatic ring, and Ester is —C(O)—O— or —O—C(O)—.

5. The process according to claim 4, wherein the compound or each of the compounds in the combination of compounds has a peak melting point ranging from 170° C. to 300° C.

6. The process according to claim 4, wherein the compound or the combination of compounds are applied at a concentration ranging from 0.05 to 2 wt % based on the weight of the poly-hydroxy-alkanoate, poly-lactic acid, or the combinations thereof.

7. The process according to claim 4, wherein the first temperature ranges from 5° C. to 90° C. above the onset of the melting point of the poly-hydroxy-alkanoate, poly-lactic acid, or the combinations thereof.

8. The process according to claim 4, wherein the second temperature ranges from 50° C. above the onset of the melting point of the poly-alkanoate-alkanoate, poly-lactic acid, or the combinations thereof to 20° C. below the glass transition temperature of the poly-hydroxy-alkanoate, poly-lactic acid, or the combinations thereof.

9. The process according to claim 4, wherein the cooling occurs at a rate ranging from 1° C./min to 500° C./min.

10. A composition comprising a polymer and a compound or a combination of compounds, wherein:
the polymer is poly-hydroxy-alkanoate, poly-lactic acid, or combinations thereof,
the compound or each of the compounds in the combination of compounds comprises a core motif with two oxalamide motifs, flanked by two arms,
wherein the core motif has the formula:
R—NH—C(O)—C(O)—NH—(CH₂)ₙ—NH—C(O)—C(O)—NH—R′,
wherein n ranges from 1 to 10 and the arms R and R′ are each independently of one another selected from the group consisting of:
(i) H;
(ii) an alkyl group with a total number of carbon atoms ranging from 1 to 20;
(iii) an aromatic ring; and
(iv) one of the following esters:
—X-Ester-Y,
—X-Ester-X-Ester-Y,
—X-Ester-X-Ester-X-Ester-Y,
—X-Ester-X-Ester-X-Ester-X-Ester-Y,
—X-Ester-X-Ester-X-Ester-X-Ester-X-Ester-Y,
—X-Ester-X-Ester-X-Ester-X-Ester-X-Ester-X-Ester-Y,
—X-Ester-X-Ester-X-Ester-X-Ester-X-Ester-X-Ester-X-Ester-Y, or
—X-Ester-X-Ester-X-Ester-X-Ester-X-Ester-X-Ester-X-Ester-X-Ester-Y;
wherein X is a saturated aliphatic hydrocarbon group comprising 1 to 20 carbon atoms, Y is selected from the group consisting of H, an alkyl group with a total number of carbon atoms ranging from 1 to 20, and an aromatic ring, and Ester is —C(O)—O— or —O—C(O)—.

11. The composition according to claim 10, wherein the compound or the combination of compounds is applied at a concentration ranging from 0.05 to 2 wt %, based on the weight of the polymer.

12. The composition according to claim 10, wherein the composition is for the production of biodegradable polymer products.

13. The process according to claim 3, wherein the compound or the at least one compound in the combination of compounds is applied in a range of from 0.1 to 1 wt % based on the weight of the poly-hydroxy-alkanoate, poly-lactic acid, or the combinations thereof.

14. The process according to claim 13, wherein the compound or the at least one of the combination of compounds is applied in a range of from 0.25 to 0.5 wt % based on the weight of the poly-hydroxy-alkanoate, poly-lactic acid, or the combinations thereof.

15. The process according to claim 7, wherein the first temperature ranges from 5° C. to 60° C. above the onset of the melting point of the poly-hydroxy-alkanoate, poly-lactic acid, or the combinations thereof.

16. The process according to claim 8, wherein the second temperature ranges from 30° C. above the onset of the melting point of the poly-hydroxy-alkanoate, poly-lactic acid, or the combinations thereof to 10° C. below the glass transition temperature of the poly-hydroxy-alkanoate, poly-lactic acid, or the combinations thereof.

17. The process according to claim 16, wherein the second temperature ranges from 10° C. above the onset of the melting point of the poly-hydroxy-alkanoate, poly-lactic acid, or the combinations thereof to about the glass transition temperature of the poly-hydroxy-alkanoate, poly-lactic acid, or the combinations thereof.

18. The process according to claim 9, wherein the cooling occurs at a rate ranging from 10° C./min and 300° C./min.

19. The composition according to claim 11, wherein the compound or the combination of compounds is applied at a concentration ranging from 0.1 to 1 wt % based on the weight of the polymer.

20. The composition according to claim 19, wherein the compound or the combination of compounds is applied at a concentration ranging from 0.25 to 0.5 wt % based on the weight of the polymer.
